(19) United States
(12) Patent Application Publication
(10) Pub. No.: US 2014/0356032 A1
(43) Pub. Date: Dec. 4, 2014

(54) DEVELOPING ROLLER, DEVELOPING DEVICE, AND IMAGE FORMING APPARATUS

(71) Applicant: FUJI XEROX CO., LTD., Tokyo (JP)

(72) Inventors: Jun ABE, Ebina-shi (JP); Yasuaki WATANABE, Ebina-shi (JP); Tomoyuki YOSHII, Ebina-shi (JP); Takashi OCHI, Ebina-shi (JP)

(73) Assignee: FUJI XEROX CO., LTD., Tokyo (JP)

(21) Appl. No.: 14/151,469

(22) Filed: Jan. 9, 2014

(30) Foreign Application Priority Data
Jun. 3, 2013 (JP) 2013-117204

(51) Int. Cl. G03G 15/09

(52) U.S. Cl. CPC G03G 15/0887
USPC 399/277

(57) ABSTRACT

A developing roller includes a cylindrical transporting member and a magnet member. The transporting member is disposed so as to rotate with a gap being disposed between the transporting member and a latent image carrying member that rotates. The transporting member carries and transports magnetic developer, and is formed of a nonmagnetic material. The magnet member is disposed with multiple magnetic poles being fixed in a cylindrical interior of the transporting member. In the developing roller, multiple magnetic members are disposed in a regular arrangement at a carrying surface of the transporting member that carries the developer.

### CROSS-REFERENCE TO RELATED APPLICATIONS

This application is based on and claims priority under 35 USC 119 from Japanese Patent Application No. 2013-117204 filed Jun. 3, 2013.

### BACKGROUND

(i) Technical Field

The present invention relates to a developing roller, a developing device, and an image forming apparatus.

(ii) Related Art

Image forming apparatuses (such as printers, copying machines, and facsimiles) to which an image recording system such as an electrophotographic system is applied include a developing device that develops an electrostatic latent image, which is formed on a latent image carrying member (such as a photoconductor member) that rotates, using magnetic developer. The magnetic developer is, for example, a two-component developer including nonmagnetic toner and a magnetic carrier, or a magnetic one-component developer.

### SUMMARY

According to an aspect of the invention, there is provided a developing roller including a cylindrical transporting member and a magnet member. The transporting member is disposed so as to rotate with a gap being disposed between the transporting member and a latent image carrying member that rotates. The transporting member carries and transports magnetic developer, and is formed of a nonmagnetic material. The magnet member is disposed with multiple magnetic poles being fixed in a cylindrical interior of the transporting member. In the developing roller, multiple magnetic members are disposed in a regular arrangement at a carrying surface of the transporting member that carries the developer.

### BRIEF DESCRIPTION OF THE DRAWINGS

Exemplary embodiments of the present invention will be described in detail based on the following figures, wherein:

FIG. 1 illustrates a principal portion of an image forming apparatus using a developing device according to a first exemplary embodiment;

FIG. 2 is a schematic sectional view of the developing device used in the image forming apparatus shown in FIG. 1;

FIG. 3 illustrates magnetic poles and magnetic flux density distribution of a magnet roller of a developing roller in the developing device shown in FIG. 2;

FIG. 4 is an enlarged perspective view of a principal portion of a sleeve of the developing roller in the developing device shown in FIG. 2;

FIGS. 5A and 5B are each an enlarged schematic view showing a state of each magnetic member disposed at the sleeve shown in FIG. 4, with FIG. 5A being an explanatory plan view thereof and FIG. 5B being a sectional explanatory view taken along line VB-VB of FIG. 5A;

FIG. 6 is an explanatory plan view showing in a further enlarged form the state of disposition of the magnetic members shown in FIG. 5A;

FIGS. 7A to 7C illustrate steps of a method of forming the sleeve shown in FIG. 4;

FIG. 8 is schematic sectional explanatory view showing a portion of the sleeve shown in FIG. 4 in an enlarged form;

FIGS. 9A and 9B each illustrate a sleeve of a developing roller according to a second exemplary embodiment, with FIG. 9A being an enlarged schematic plan explanatory view of a state of each magnetic member disposed at the sleeve and FIG. 9B being a sectional explanatory view taken along line IXB-IXB of FIG. 9A;

FIG. 10 is a schematic sectional explanatory view showing a portion of the sleeve shown in FIG. 9B in an enlarged form;

FIG. 11 is an enlarged schematic sectional explanatory view of another exemplary structure of the sleeve of the developing roller;

FIGS. 12A and 12B are enlarged schematic sectional explanatory views of two other exemplary structures of a portion of the sleeve of the developing roller where the magnetic members are provided;

FIGS. 13A to 13C illustrate steps of another method of forming the sleeve shown in FIG. 4; and

FIG. 14 is a schematic sectional explanatory view showing in an enlarged form a portion of a sleeve provided with grooves according to a comparative example.

### DETAILED DESCRIPTION

Exemplary embodiments of the present invention are hereunder described with reference to the drawings.

### First Exemplary Embodiment

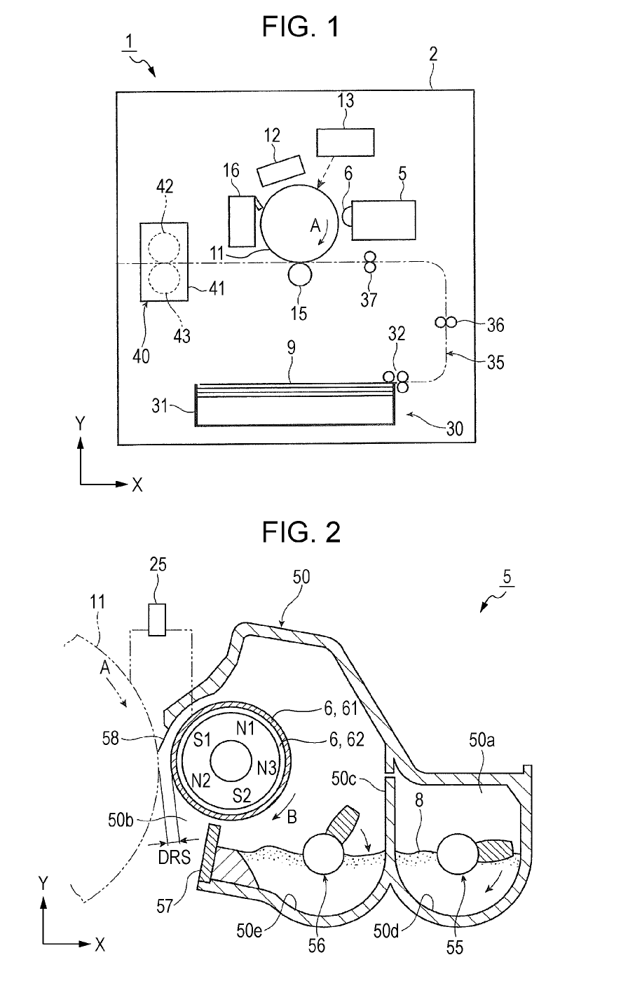

FIGS. 1 and 2 each illustrate an image forming apparatus 1 to which a developing device 5 according to a first exemplary embodiment is applied. FIG. 1 schematically illustrates the image forming apparatus 1. FIG. 2 schematically illustrates the developing device 5.

### Image Forming Apparatus

As shown in FIG. 1, the image forming apparatus 1 includes an image forming device 10, a sheet feeding device 30, and a fixing device 40, which are disposed in an internal space of a housing 2 (formed of, for example, a supporting member and an external member). The image forming device 10 forms a toner image formed using developer, and transfers the toner image to a sheet 9. The sheet feeding device 30 contains sheets 9 to be supplied to the image forming device 10, and sends out the sheets 9. The fixing device 40 fixes the toner image that has been transferred at the image forming device 10 to the sheet 9. An alternate long and short dash line in FIG. 1 indicates a principal sheet transport path along which a sheet 9 is transported in the housing 2.

The image forming device 10 is formed by using, for example, an electrophotographic system that is publicly known. The image forming device 10 primarily includes a photoconductor drum 11, a charging device 12, an exposure device 13, the developing device 5, a transfer device 15, and a cleaning device 16. The photoconductor drum 11 is rotationally driven in the direction of arrow A (that is, clockwise in FIG. 1). The charging device 12 charges the peripheral surface of the photoconductor drum 11 to a required potential. The exposure device 13 irradiates the charged peripheral surface of the photoconductor drum 11 with light that is based on image information (signal), and forms an electrostatic latent image having a potential difference. The developing device 5 forms the electrostatic latent image into a toner image by developing the electrostatic latent image with toner of a two-component developer. The transfer device 15 transfers the toner image to the sheet 9. The cleaning device 16 cleans the peripheral surface of the photoconductor drum 11 by removing, for example, residual toner on the peripheral surface of the photoconductor drum 11 after the transfer.

The photoconductor drum 11 is, for example, one that includes a photosensitive layer (formed of, for example, an organic photosensitive material) provided along an outer peripheral surface of a cylindrical conductive base that is connected to ground. The charging device 12 is a contact or a non-contact charging device. As the exposure device 13, a laser beam scanning device in which a semiconductor laser and various optical components are combined or a light emitting diode (LED) array in which light emitting diodes (LEDs) and various optical components are combined is used. The exposure device 13 irradiates the photoconductor drum 11 with light that is based on an image signal that is obtained by performing a required processing operation on image information using an image processing device (not shown). The image information is input from an image generating source (such as a document reading device, an external connecting device, or a storage medium reading device) that is connected to or provided at the image forming apparatus 1.

The developing device 5 is one that uses a two-component developer 8 including nonmagnetic toner and magnetic carriers (particles). As shown in, for example, FIG. 2, using the developing roller 6, the developing device 5 performs development by carrying and transporting the two-component developer 8 in the form of a magnetic brush (in which the magnetic carriers to which the nonmagnetic toner adheres stand in the form of a chain) and causing it to contact the peripheral surface of the photoconductor drum 11 (that is, a portion of the photoconductor drum 11 where an electrostatic latent image is formed) using the developing roller 6. Here, the developing roller 6 rotates so that a direction of movement of a portion of the developing roller 6 that approaches the photoconductor drum 11 is in the opposite direction (that is, the direction of arrow B). The developing device 5 is described in detail below.

The transfer device 15 is a contact or a non-contact transfer device. The cleaning device 16 is, for example, one in which a cleaning blade and a rotating brush that contact the peripheral surface of the photoconductor drum 11 are caused to contact the peripheral surface of the photoconductor drum 11. When an image is to be formed (image formation operation is to be executed), a charging voltage, a development voltage, and a transfer voltage are applied to the charging device 12, (the developing roller 6) of the developing device 5, and the transfer device 15, respectively, from a power supply device (not shown).

The sheet feeding device 30 includes a sheet container 31 and a sending-out unit 32. The sheet container 31 contains stacked sheets 9 that are of, for example, required sizes and types and that are used for forming an image. The sending-out unit 32 sends out the sheets 9, which are contained in the sheet container 31, one at a time towards the sheet transport path. The sheet container 31 is mounted so that it is capable of being drawn out from the housing 2 when, for example, replenishing the sheet container 31 with sheets 9. More than one sheet container 31 is provided depending upon the mode of use. A sheet feed path 35 is provided between the sheet feeding device 30 and a transfer position of the image forming device 10 (that is, between the photoconductor drum 11 and the transfer device 15). The sheet feed path 35 is defined by, for example, pairs of transport rollers 36 and 37 and a transport guide member. When it is time to perform an image formation operation, the sheet feeding device 30 sends out required sheets 9 one at a time to the sheet feed path 35.

The fixing device 40 includes a rotationally driven heating rotating member 42 and a pressing rotating member 43 in the housing 41. The heating rotating member 42 is in the form of, for example, a roller or a belt. The surface temperature of the heating rotating member 42 is increased to and maintained at a required temperature by a heating unit. The pressing rotating member 43 is in the form of, for example, a driven rotating roller or belt. The pressing rotating member 43 contacts with a required pressure the heating rotating member 42 substantially along an axial direction thereof, and is driven and rotated. The fixing device 40 fixes an unfixed toner image to a sheet 9 by causing the sheet 9 to which the unfixed image has been transferred to pass a contact portion (that is, a fixing processing portion) formed between the heating rotating member 42 and the pressing rotating member 43, and by fusing the unfixed toner image under pressure.

The image forming apparatus 1 forms an image as follows. Here, the method of forming an image is described taking as an example a basic image formation operation that is performed when an image is formed on one surface of a sheet 9.

When the image forming apparatus 1 receives an instruction to start image formation, in the image forming device 10, the outer peripheral surface of the photoconductor drum 11 that starts to rotate in the direction of arrow A is charged to a predetermined polarity and potential by the charging device 12. Then, the exposure device 13 performs exposure on the charged peripheral surface of the photoconductor drum 11 to form an electrostatic latent image having a required potential. The exposure is based on image information. Next, when the electrostatic latent image that is formed on the photoconductor drum 11 passes the developing device 5, the electrostatic latent image is developed using toner of the two-component developer 8 supplied from the developing roller 6, and is made visible as a toner image.

Next, when the toner image that is formed on the photoconductor drum 11 is transported by the rotation of the photoconductor drum 11 to the transfer position that opposes the transfer device 15, the transfer device 15 transfers the toner image to the sheet 9 that is supplied from the sheet feeding device 30 via the sheet feed path 35 in accordance with the timing in which the toner image is transported to the transfer position. The peripheral surface of the photoconductor drum 11 after the transfer is cleaned by the cleaning device 16.

Next, the sheet 9 to which the toner image has been transferred is separated from the photoconductor drum 11, is transported so as to enter the fixing processing portion of the fixing device 40, and is subjected to a fixing operation (heating and pressing operation), so that the toner image is fixed. The sheet 9 after the fixing operation is completed is discharged from the fixing device 40, and is held by, for example, a discharge holding section (not shown) that is provided at, for example, an outer portion of the housing 2.

By the above-described operations, a monochromatic image formed of toner of one color is formed on one surface of one sheet 9, and the basic image formation operation ends. When there is a request to form images on multiple sheets, the above-described operations are similarly repeated for the required number of sheets.

### Developing Device

Next, the developing device 5 is described in detail. As shown in, for example, FIG. 2, the developing device 5 includes a body 50 including a chamber 50a and a rectangular opening 50b. The chamber 50a contains the aforementioned two-component developer 8. The opening 50b is formed at a position that faces the photoconductor drum 11. The body 50 is an elongated container having a length that is greater than the length of the photoconductor drum 11 in an axial direction thereof. Two developer circulating transport paths (grooved portions) 50d and 50e are formed parallel to each other at the bottom portion of the chamber 50a. The developer circulating transport paths 50d and 50e are connected to each other at both ends of elongated container shapes of the developer circulating transport paths 50d and 50e in a longitudinal direction thereof, and are divided from each other by a central partition wall along the longitudinal direction. The two-component developer 8 is contained in the container 50a.

The developing device 5 includes, for example, the developing roller 6, two screw augers 55 and 56, and a regulating plate 57, which are disposed in the body 50. The developing roller 6 carries and transports the two-component developer 8 up to a development area that opposes the photoconductor drum 11 with magnetic force. The screw augers 55 and 56 serve as stirring transporting members that stir and transport the two-component developer 8 that is contained in the chamber 50a. The regulating plate 57 regulates the passage of the two-component developer 8 that is supplied to the developing roller 51 from the screw auger 56, and regulates the thickness (transport amount) of a layer of the two-component developer 8. Reference numeral 58 in FIG. 2 denotes a leakage prevention film that prevents leakage of the developer 8 from a gap between the photoconductor drum 11 and the opening 50b in the body.

The developing roller 6 includes a cylindrical sleeve 61, serving as a transporting member, and a magnet roller 62, serving as a magnet member. The sleeve 61 is disposed so as to rotate in the direction of arrow B while a portion thereof is exposed to the opening 50b of the body 50. The magnet roller 62 is provided so as to exist while being fixed to the circular cylinder of the sleeve 61.

Using a nonmagnetic material (such as stainless steel or aluminum), the sleeve 61 is formed so as to include a cylindrical portion having a width (length) that is substantially equal to that of an effective image formation area of the photoconductor drum 11 in the direction of a rotation axis. The sleeve 61 is disposed so as to oppose the photoconductor drum 11 with the direction of a rotation axis thereof being substantially parallel to the direction of the rotation axis of the photoconductor drum 11. In addition, the sleeve 61 is disposed so that the size of a gap DRS between it and the photoconductor drum 11 (gap between the photoconductor drum 11 and the developing roller 6) is within a required range (200 to 500 μm). End portions (serving as shaft portions) of the sleeve 61 are actually mounted to corresponding side portions of the body 50 or shaft portions of the magnet roller 62 while the end portions are rotatably supported. The sleeve 61 is subjected to power from a rotationally driving device (not shown) through the shaft portions, so that the sleeve 61 is rotated in the direction of arrow B. Further, a development voltage (development bias) for forming a development electric field between the sleeve 61 and the photoconductor drum 11 is supplied to the sleeve 61 from a power supplying device 25 (FIG. 2). As the development voltage, for example, a direct current voltage on which an alternating-current component is superimposed is supplied.

The magnet roller 62 includes magnetic poles (S poles and N poles) that generate, for example, magnetic lines of force that cause the two-component developer 8 to be carried while magnetic carriers of the two-component developer 8 adhere to toner and a magnetic brush is formed (so as to stand in the form of a chain) at the outer peripheral surface of the sleeve 61. For example, the magnet roller 62 is mounted while end portions thereof are secured to the side portions of the body 50 via an internal space at the shaft portions of the sleeve 61. The magnetic poles extend along an axial direction of the sleeve 61, and are disposed at required positions so as to be spaced apart from each other in a peripheral direction (direction of rotation) of the sleeve 61.

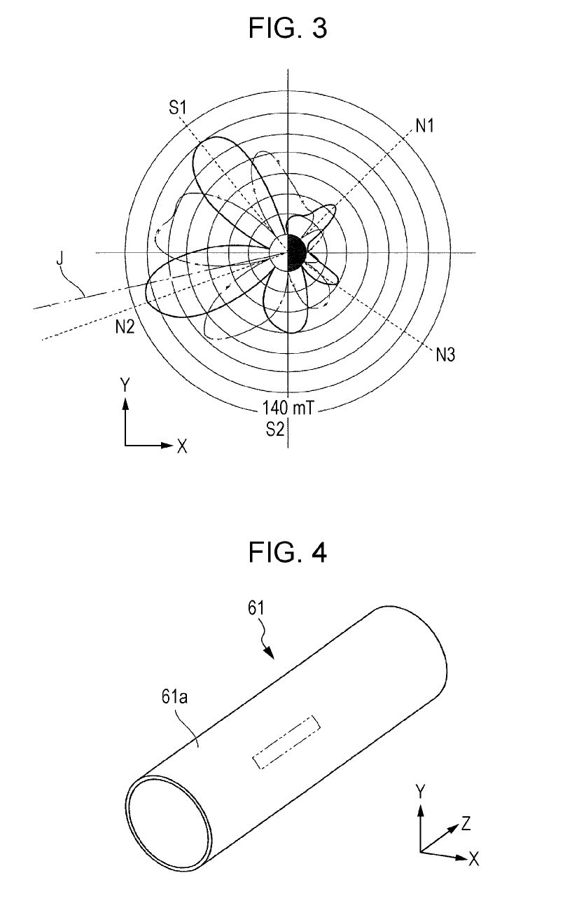

For example, as shown in FIG. 3, five magnetic poles, that is, S2, N2, S1, N1, and N3 are disposed in the magnet roller 62. Of the magnetic poles, the magnetic pole S2 is a pickup pole that is disposed so as to substantially oppose the regulating plate 57, and that, using magnetic force, causes the two-component developer 8 that is supplied from the screw auger 56 (that is near the developing roller 6) to be pulled towards and carried by the outer peripheral surface of the sleeve 61. The magnetic pole N2 is a principal development pole that is disposed so as to substantially oppose the development area of the photoconductor drum 11, and that causes the two-component developer 8 to contribute to a development process. The magnetic pole S1 is a transport pole. The magnetic poles N1 and N3 are pick-off poles that cause the two-component developer 8 to be separated from the outer peripheral surface of the sleeve 61. In FIG. 3, a thick solid line indicates a magnetic flux density distribution of a vertical component, and an alternate long and short dash line indicates a magnetic flux density distribution of a horizontal component. Concentric circles in FIG. 3 are circles that indicate 20 mT ranges of magnetic flux densities that gradually increase from the center towards the outer side. A reference line J in FIG. 3 is a straight line connecting the center of the developing roller 51 and the center of the photoconductor drum 11.

As shown in FIG. 2, the screw augers 55 and 56 are each of a type in which a transport blade is spirally wound around a peripheral surface of a rotary shaft. The screw augers 55 and 56 are rotatably disposed in the developer circulating transport paths 50d and 50e in the chamber 50a of the body 50, respectively. The screw augers 55 and 56 are rotationally driven in required directions corresponding to directions in which the portions of the two-component developer 8 that are in the transport paths 50d and 50e are to be transported. The screw augers 55 and 56 are formed so as to rotate when a portion of the power of the rotationally driving device that rotates the sleeve 61 of the developing roller 6 is divided and is transmitted to the augers 55 and 56. The screw auger 56 that is disposed near the developing roller 6 is such that a portion of the developer 8 that the screw auger 56 transports is transferred and supplied to the developing roller 6.

As shown in FIG. 2, the regulating plate 57 is a rectangular plate member whose principal portion has a substantially constant thickness and a length that is at least equal to the length of the sleeve 61 of the developing roller 6 in the axial direction thereof (long side). The regulating plate 57 is formed of a nonmagnetic material (such as stainless steel). Further, the regulating plate 57 is in a state in which its end portion in a longitudinal direction thereof (long side portion below the sleeve 61) faces the outer peripheral surface of the sleeve 61 so as to be spaced therefrom by a required gap (regulation interval). In addition, the regulating plate 57 is mounted to the body 50 so as to extend along the axial direction of the sleeve 61 and face the body 50.

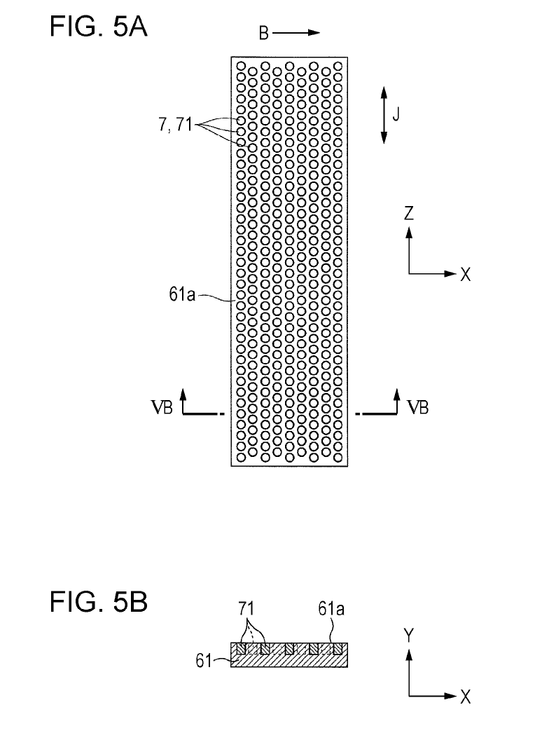

In the developing device 5, as shown in FIGS. 4 and 5A and 5B, as the sleeve 61 of the developing roller 6, a sleeve in which magnetic members 7 are disposed in a regular arrangement at an outer peripheral surface (carrying surface) 61a that carries the two-component developer 8 is used.

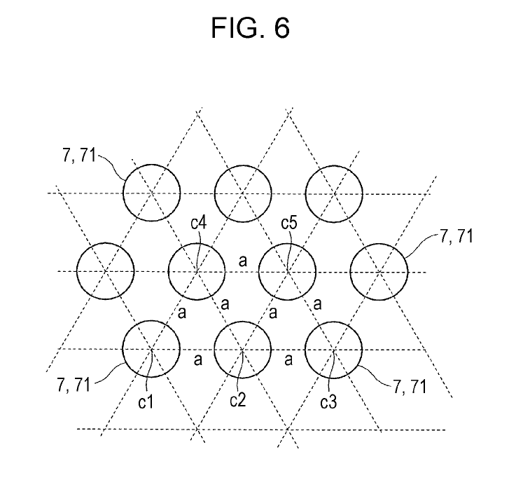

In the sleeve 61 according to the first exemplary embodiment, as schematically shown in enlarged forms in FIGS. 5A to 6, a portion of the outer peripheral surface 61a of the sleeve 61 that is shown in FIG. 4 and surrounded by an alternate long and two short dashes line uses, as magnetic members 7, magnetic members 71 whose surface portions that are exposed at the outer peripheral surface 61a of the sleeve are circular. The magnetic members 71 are disposed in a staggered pattern. The staggered pattern is, in other words, a pattern in which the magnetic members 71 are linearly arranged in rows and at equal intervals in a rotation axis direction J of the sleeve 61 and in which the magnetic members 71 exist at equal intervals in a rotation direction B of the sleeve 61, with the magnetic members 71 existing at intermediate portions with respect to the magnetic members 71 in the front and back rows in the rotation direction B.

As shown in FIG. 6, the magnetic members 71 are disposed so that a distance a between their centers c (c1, c2, . . . , cn, where n is an integer) is 0.2 mm to 0.6 mm. The magnetic members 71 at this time are separated from each other (are not in contact with each other). If the distance a is less than 0.2 mm, for example, the standing chains are connected to each other because the distance between the standing chains is too small. In contrast, if the distance a exceeds 0.6 m, for example, improper transport of the developer occurs.

When the distance between the centers c of the magnetic members 71 is a (mm), each magnetic member 71 is disposed so that an area S of its surface portion is π(a/4)² to π(a/2)². In this case, (a/4) and (a/2) in the area S is a value equivalent to the radius of each magnetic member 71 whose flat portion is circular in shape. If the area S (mm²) is less than π(a/4)², for example, developer is improperly transported. In contrast, if the area S exceeds π(a/2)², the standing chains are connected to each other because the distance between the standing chains is too small. The areal percentage of each magnetic member 71 with respect to the outer peripheral surface 61a of the sleeve (effective development area) is of the order of 20 to 40%.

Incidentally, the conditions of the center distance a and the area S regarding the magnetic members 71 are primarily set under the following preconditions.

That is, as the sleeve 61, a cylindrical member having an outside diameter of from 15 to 30 mm may be used; and, as the two-component developer 8, developer including nonmagnetic toner having a volume mean particle diameter of 2 μm to 10 μm and magnetic carriers having a volume mean particle diameter of 20 μm to 50 μm may be used. Further, the rotation speed of the sleeve 61 is assumed to be 30 to 90 cm/s, and a gap DRS between the sleeve 61 and the photoconductor drum 11 is assumed to be 200 to 500 μm in size. These preconditions are the same for, for example, a second exemplary embodiment (described below).

Each of the magnetic members 71 is a soft magnetic member formed of, for example, soft ferrite.

It is desirable that at least the surface portion of each magnetic member 71 be conductive. If each magnetic member 71 is a soft magnetic member formed of, for example, iron, each soft magnetic member itself is conductive. Therefore, it is not necessary to impart conductivity to the surface portion of each magnetic member 71, so that each magnetic member 71 may be used as it is.

The sleeve 61 where each magnetic member 7 is disposed is formed, for example, in the following way.

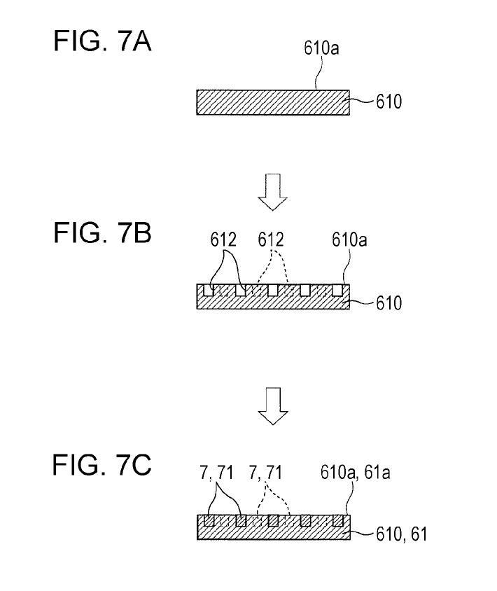

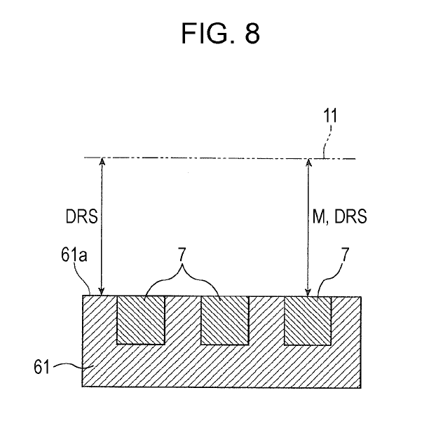

That is, as shown in FIGS. 7A and 7B, using, for example, a laser processing method, setting holes 612 having a shape corresponding to the shape of the magnetic members 7 (71) to be disposed are formed in an outer peripheral surface 610a of a base 610 of the cylindrical sleeve 61. The setting holes 612 at this time are formed as holes that are in correspondence with, for example, the shape of the surface portion of each magnetic member 7 (71) that is disposed and the center distance a and the area S thereof. In this exemplary embodiment, the holes are columnar holes. Next, as shown in FIG. 7C, using, for example, a blowing method, the material of each magnetic member 7 is embedded in each setting hole 612 formed in the base 610 of the sleeve 61 so as to fill each setting hole 612. Each magnetic member 7 at this time is caused to fill each setting hole 612 until each setting hole 612 is completely filled up. The surface portion of each magnetic member 7 embedded in its corresponding setting hole 612 is ordinarily polished and processed into a smooth surface. However, when, for example, the surface does not have a protrusion of a height that is greater than or equal to 100 μm, it is not necessary to form the surface portion of each magnetic member 7 into a smooth surface by polishing. The height of the surface portion of each magnetic member 7 (71) is the same as the height of the outer peripheral surface 61a of the sleeve. As a result of the aforementioned operations, the sleeve 61 where each magnetic member 7 is disposed is formed.

The operation of the developing device 5 is described below.

First, when it is time for the image forming apparatus 1 to perform an image formation operation, the sleeve 61 of the developing roller 6 starts rotating in the direction of arrow B, and a development voltage is applied to the sleeve 6.

As a result, the two-component developer 8 that is contained in the chamber 50a of the body 50 is transported in various directions in the circulating transport paths 50d and 50e in the chamber 50a while being stirred by the augers 55 and 56 that rotate, and is transported so as to be circulated as a whole. Here, nonmagnetic toner in the two-component developer 8 is sufficiently stirred with magnetic carriers, is frictionally charged to a required charge amount, and is set in a state in which the nonmagnetic toner is electrostatically stuck on the surfaces of the carriers.

Next, the two-component developer 8 that is transported by the screw auger 56 (disposed near the developing roller 51) is such that a portion thereof is attracted to and carried by the outer peripheral surface 61a of the sleeve 61 of the developing roller 6 by magnetic force. That is, when magnetic force that is generated by magnetic lines of force that are generated from the magnetic pole S2 of the magnet roller 62 acts upon the outer peripheral surface 61a of the sleeve 61 that rotates, this portion of the two-component developer 8 is carried by the outer peripheral surface 61a of the sleeve 61 while magnetic brushes 80 (in which the magnetic carriers to which the nonmagnetic toner adheres stand in the form of a chain) are formed. In the carried state, this portion of the two-component developer 8 is supplied. Thereafter, this portion of the two-component developer 8 that is carried by the sleeve 61 of the developing roller 6 is transported to a portion of the sleeve 61 that the regulating plate 57 opposes, and is regulated to a substantially constant layer thickness (transport amount) at the outer peripheral surface 61a of the sleeve 61 as a result of regulating the passage of this portion of the two-component developer 8 so as to prevent its passage when this portion of the two-component developer 8 passes through the gap between the regulating plate 57 and the sleeve 61.

Next, when the two-component developer 8 is transported by the sleeve 61 that rotates, and contacts and passes the development area that opposes the photoconductor drum 11, the two-component developer 8 that has been regulated by the regulating plate 57 is subjected to magnetic force of the development magnetic pole N2 of the magnet roller 62 and electrostatic action of a development electric field generated by a development voltage. This causes the toner of the magnetic brushes of the two-component developer 8 transported by the sleeve 61 to move to the outer peripheral surface of the photoconductor drum 11, and adhere to a latent image portion that passes the development area, so that the latent image portion is developed.

Next, the two-component developer 8 that has passed the development area is carried and transported by the sleeve 61, which rotates, by magnetic force of the transport pole S1 of the magnet roller 62, after which the two-component developer 8 is separated from the outer peripheral surface 61a of the sleeve 61 without being subjected to a strong attractive magnetic force when the two-component developer 8 passes between the magnetic poles N1 and N3 (separation poles) of the magnet roller 62, and eventually returns to the chamber 50a.

In particular, in this developing device 5, a magnetic line of force that is generated from each magnetic pole of the magnet roller 62 at the outer peripheral surface 61a of the sleeve 61 of the developing roller 6 is concentrated at and passes each magnetic member 7 (71). By this, the two-component developer 8 is formed in the form of magnetic brushes with each magnetic member 71 being a center, is carried by the outer peripheral surface 61a of the sleeve 61, and is properly transported by the rotation of the sleeve 61 while being kept in the carried state. In the development area that opposes the photoconductor drum 11, the two-component developer 8 contacts the outer peripheral surface of the photoconductor drum 11 while reliably forming a magnetic brush as a result of being subjected to magnetic force when the magnetic line of force that is generated from the principal development pole N2 is concentrated at and passes each magnetic member 71; and is subjected to electrostatic action of a development electric field. As a result, the toner of the developer 8 precisely adheres to only the latent image portion of the photoconductor drum 11, so that development is efficiently performed.

The magnetic members 71 at the outer peripheral surface 61a of the sleeve 61 are soft magnetic members. Therefore, when the two-component developer 8 passes an area where a magnetic field is not generated by magnetic lines of force at a location between the magnetic poles N1 and N3, which are separation poles, of the magnet roller 62 after the two-component developer 8 has passed the development area, since the magnetic members 71, which are soft magnetic members, do not remain magnetized, the two-component developer 8 is properly separated without being subjected to magnetic force from the outer peripheral surface 61a of the sleeve 71 when the two-component developer 8 passes the area where the magnetic field is not generated. By this, the outer peripheral surface 61a of the sleeve 61 carries (attracts) new two-component developer 8 without the two-component developer 8 being carried by the outer peripheral surface 61a after passing the development area. Therefore, the developer is properly replaced. Even from this, efficient development and proper transport of the two-component developer 8 on the sleeve 61 are ensured.

Each magnetic member 71 at the outer peripheral surface 61a of the sleeve 61 is conductive. Therefore, at the sleeve 61 when the two-component developer 8 passes the development area, the outer peripheral surface 61a of the sleeve 61 and each magnetic member 71 become the same potential by the supply of development voltage. The development electric field stably and uniformly acts upon the two-component developer 8 (actually toner that is charged) where magnetic brushes are formed as a result of concentration of the development electric field at each magnetic member 71. Even from this, efficient development using the two-component developer 8 is ensured.

Further, each magnetic member 7 at the outer peripheral surface 61a of the sleeve 61 exists at equal intervals with the center distance a being small in the range of 0.2 mm to 0.6 mm. Therefore, the two-component developer 8 is used for development while the outer peripheral surface 61a of the sleeve 61 carries the two-component developer 8 in a regular arrangement and in a dense state in correspondence with each magnetic member 71. This causes the latent image on the photoconductor drum 11 to be developed with toner properly adhered to the latent image and with good graininess. In addition, since each magnetic member 71 at the outer peripheral surface 61a of the sleeve 61 exists in the small area S that is π(a/4)² to π(a/2)², the area S is substantially equal to the area of the bottom of the magnetic brush of the two-component developer 8, and magnetic lines of force is capable of being concentrated at the two-component developer 8 that is carried while a magnetic brush is formed at each magnetic member 71. Even from this, efficient development and proper transport of the two-component developer 8 at the sleeve 61 are ensured.

Further, according to the developing device 5, for example, it is possible to prevent a reduction in development efficiency that occurs when, in order to increase transportability of the developer, a sleeve including regularly provided grooves 66 extending in an axial direction in the outer peripheral surface 61a of the sleeve 61 of the developing roller 6 is used.

That is, when the sleeve 65 including the grooves 66 is used, transportability of the developer is ensured by carrying the developer so as to form magnetic brushes with the grooves 66 as centers. However, strictly speaking, the gap DRS between the sleeve 65 and the photoconductor drum 11 becomes, at each groove 66, a distance L that is greater than DRS by a depth d of each groove 66, as a result of which the distance between the photoconductor drum 11 and the sleeve 65 at the location of each groove 66 differs from that at the locations where the grooves 66 are not formed. Consequently, in the sleeve 65, the development electric field at each groove 66 is reduced, as a result of which the development efficiency tends to be reduced. The depth d and a width w (length in the rotation direction B) of each groove 66 are of the order of 100 μm and 100 μm, respectively.

In contrast, in the developing roller 6 according to the first exemplary embodiment, instead of forming the grooves 66, the magnetic member 7 (71) are formed in a regular arrangement in the sleeve 61. Therefore, a gap M between the photoconductor drum 11 and each magnetic member 7 (71) is about the same size as the gap DRS between the photoconductor drum 11 and the outer peripheral surface 61a of the sleeve. Consequently, the development electric field at each magnetic member 7 (71) at the sleeve 61 is not reduced. As a result, the development efficiency is not reduced.

### Second Exemplary Embodiment

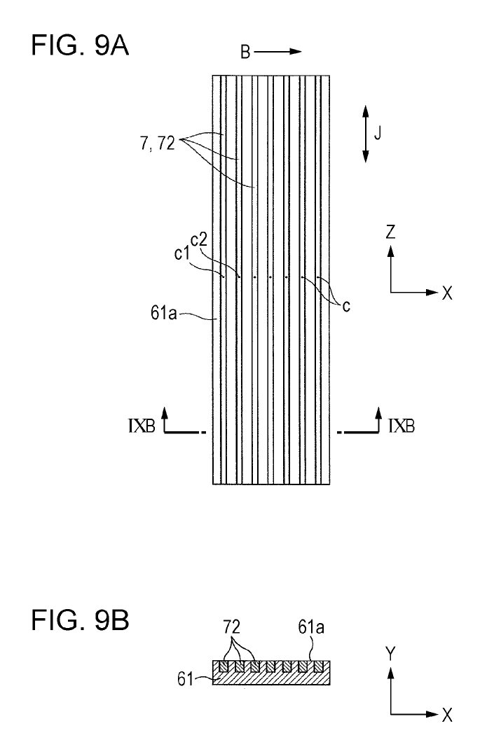

FIGS. 9A and 9B illustrate a sleeve 61 of a developing roller 6 in a developing device 5 according to a second exemplary embodiment.

The sleeve 61 of the developing roller 6 according to the second exemplary embodiment has the same structure as the sleeve 61 of the developing roller 6 according to the first exemplary embodiment except that the magnetic members 7 are disposed in a different pattern.

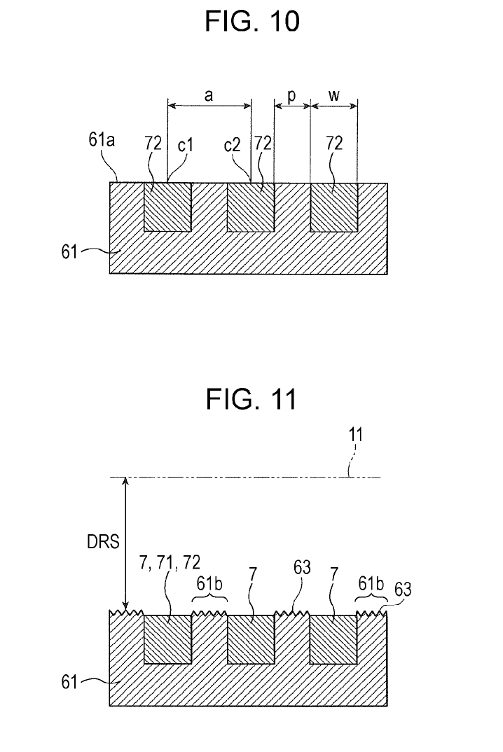

That is, in the sleeve 61, as shown in FIGS. 9A and 9B and 10, in place of the magnetic members 7, magnetic members 72 whose surface portions are long and rectangular and are exposed at an outer peripheral surface 61a of the sleeve are used. The magnetic members 72 are disposed in a striped pattern in which the magnetic members 72 are spaced at an equal interval p in a rotation direction B of the sleeve 61 and are arranged parallel to an axial direction J of the sleeve 61. Symbol w in FIG. 10 denotes the width of a magnetic member 72.

As shown in FIGS. 9A and 9B and 10, each magnetic member 72 at this time is disposed so that a distance a between centers c (c1, c2, . . . , cn, where n is an integer) is 0.2 mm to 0.6 mm. The magnetic members 72 are separated from each other (are not in contact with each other). Further, the magnetic members 72 are soft magnetic members as are the magnetic members 71 according to the first exemplary embodiment.

Even the developing device 5 including the sleeve 61 where the magnetic members 72 are disposed provides advantages that are substantially the same as those provided by the developing device 5 according to the first exemplary embodiment. In particular, by applying the developing roller 6, the typical effect of the second exemplary embodiment that developer is properly transported is obtained. The sleeve 61 at which the magnetic members 72 are disposed may be formed using the same method as that used in, for example, the first exemplary embodiment.

### Other Exemplary Embodiments

As shown in FIG. 11, in the sleeve 61 of the developing roller 6 according to each of the first and second exemplary embodiments, it is possible to form uneven portions 63 at an outer peripheral portion 61b where the magnetic members 7 (71, 72) are not disposed. The uneven portions 63 are fine portions in which the height of each protrusion is, for example, of the order of 2 to 30 μm. That is, it is desirable that the height of each protrusion be a value that virtually does not cause a gap DRS between the outer peripheral surface 61b and the photoconductor drum 11 to differ. In addition, when the uneven portions 63 are provided at the outer peripheral surface portion 61b, compared to the case in which the outer peripheral surface portion 61b is a smooth surface, the transportability of the developer 8 that is carried by the outer peripheral surface portion 61b is aided. As a result, the transportability of developer is further increased.

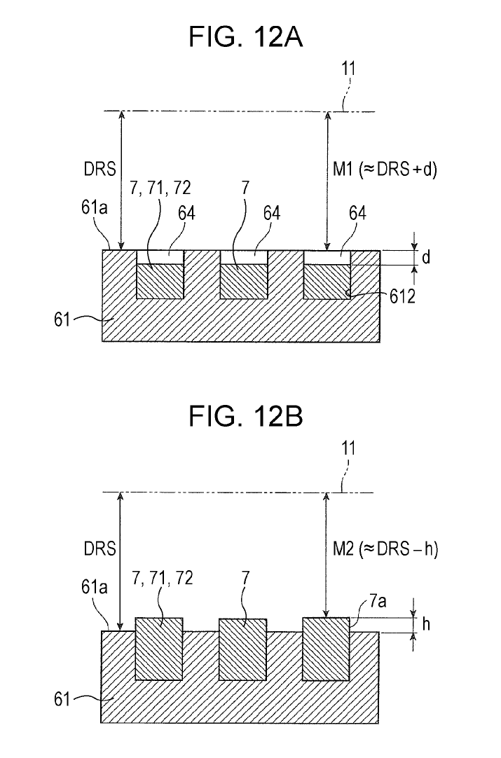

In the first and second exemplary embodiments, the magnetic members 7 (71, 72) disposed at the sleeve 61 may be provided as exemplified in FIGS. 12A and 12B.

First, each of the magnetic members 7 (71, 72) shown in FIG. 12A is provided so as to have a recess 64 in its top portion without filling the setting holes 612 completely (see FIG. 7C). In this case, strictly speaking, a gap M1 between the sleeve 6 and the photoconductor drum 11 where each recess 64 exists is larger than an actual gap DRS in correspondence with a depth d of each recess 64. However, in the exemplary embodiment, since magnetic lines of force are concentrated at and pass the corresponding magnetic members 7, the two-component developer 8 is reliably carried at each magnetic member 7. Therefore, there is no possibility of a reduction in development efficiency at a portion where each recess 64 exists. However, it is desirable that the depth d of each recess 64 be, for example, not more than 20 μm.

Next, the magnetic members 7 (71, 72) shown in FIG. 12B are provided so that their surface portions protrude from an outer peripheral surface 61a of the sleeve 61. In this case, strictly speaking, a gap M2 between the sleeve 61 and the photoconductor drum 11 where a protrusion 7a of each magnetic member 7 exists is smaller than an actual gap DRS in correspondence with a height h of the protrusion 7a. However, in this exemplary embodiment, since, for example, the development electric field is not weakened, there is no possibility of a reduction in development efficiency at a portion where each protrusion 7a exists. However, it is desirable that the height h of each protrusion 7a be, for example, not more than 20 μm.

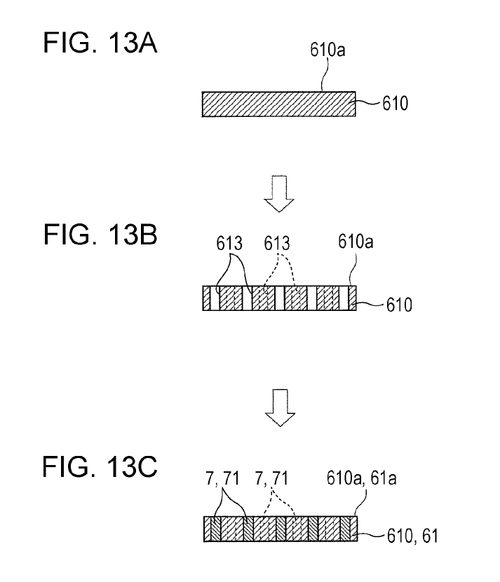

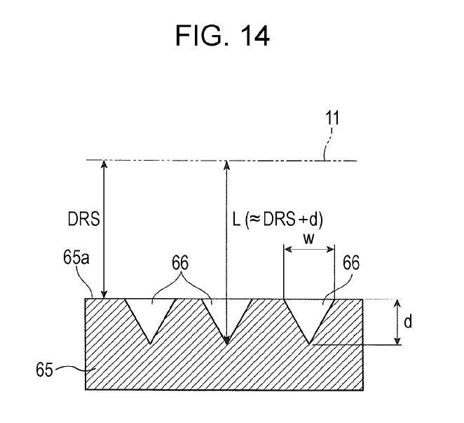

Further, in the first exemplary embodiment, the sleeve 61 where each magnetic member 71 is disposed may be formed by a method such as that shown in FIGS. 13A to 13C. That is, the method shown in FIGS. 13A to 13C only differs from the aforementioned method (illustrated in FIGS. 7A to 7C) in that setting holes 613 are formed in an outer peripheral surface 610a of a base 610 of the cylindrical sleeve 61 so as to pass therethrough and materials of the magnetic members 71 are embedded in the setting holes 613 so that the setting holes 613 are filled up with the materials. When this method is used, for example, manufacturing variations are reduced.

Further, although, in the first exemplary embodiment, two exemplary regular dispositions of the magnetic members 7 are described, as long as the magnetic members 7 is capable of being disposed in a regular arrangement, various modifications may be made regarding conditions such as the shape of the surface portion of each magnetic member and disposition patterns.

Although, in the first exemplary embodiment, the developing device 5 including one developing roller 6 is described, the present invention is similarly applicable to a developing device including multiple developing rollers. In addition, the present invention is also applicable to a developing device using a magnetic developer such as a magnetic one-component developer as developer.

As long as the image forming apparatus 1 using the developing device 5 according to the present invention is capable of using the developing device 5 (including the developing roller 6), for example, its form is not particularly limited. For example, the image forming apparatus 1 may be one that forms color images or one using an intermediate transfer system.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing roller comprising:
a cylindrical transporting member that is disposed so as to rotate with a gap being disposed between the transporting member and a latent image carrying member that rotates, the transporting member carrying and transporting magnetic developer, the transporting member being formed of a nonmagnetic material; and
a magnet member that is disposed with a plurality of magnetic poles being fixed in a cylindrical interior of the transporting member,
wherein a plurality of magnetic members are disposed in a regular arrangement at a carrying surface of the transporting member that carries the developer.

2. The developing roller according to claim 1, wherein each magnetic member is a soft magnetic member.

3. The developing roller according to claim 1, wherein at least a surface portion of each magnetic member is conductive.

4. The developing roller according to claim 1, wherein each magnetic member is disposed so that a distance between centers of the magnetic members is 0.2 mm to 0.6 mm.

5. The developing roller according to claim 1, wherein each magnetic member is disposed so that, if a distance between centers of the magnetic members is a (mm), an area S at a surface portion of each magnetic member is π(a/4)² to π(a/2)².

6. The developing roller according to claim 1, wherein a portion of the carrying surface of the transporting member where the magnetic members are not disposed is provided with an uneven portion.

7. A developing device comprising:
a developing roller including a cylindrical transporting member and a magnet member, the transporting member being disposed so as to rotate with a gap being disposed between the transporting member and a latent image carrying member that rotates, the transporting member carrying and transporting magnetic developer, the transporting member being formed of a nonmagnetic material, the magnet member being disposed with a plurality of magnetic poles being fixed in a cylindrical interior of the transporting member,
wherein the developing roller is the developing roller according to claim 1.

8. An image forming apparatus comprising:
a latent image carrying member that rotates; and
a developing device including a developing roller including a cylindrical transporting member and a magnet member, the transporting member being disposed so as to rotate with a gap being disposed between the transporting member and the latent image carrying member, the transporting member carrying and transporting magnetic developer, the transporting member being formed of a nonmagnetic material, the magnet member being disposed with a plurality of magnetic poles being fixed in a cylindrical interior of the transporting member,
wherein the developing device is the developing device according to claim 7.
